(19) United States
(12) Patent Application Publication
(10) Pub. No.: US 2003/0014254 A1
(43) Pub. Date: Jan. 16, 2003

(54) Load-shared distribution of a speech system

(76) Inventors: You Zhang, Pleasanton, CA (US); Mani Ram, Pleasanton, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 09/904,372

(22) Filed: Jul. 11, 2001

(51) Int. Cl. G10L 13/08

(52) U.S. Cl. 704/260

(57) ABSTRACT

A method is afforded for providing a load-shared distribution architecture speech system over a network. A speech system is disassembled into independent modules. The modules are divided into separate parts. A portion of a computational capacity of at least one of a plurality of devices utilized by the separate parts of the modules is determined. The modules are then deployed over a network to at least one of the plurality of devices, depending on the computational capacity thereof.

### TECHNICAL FIELD

The present invention relates generally to automatic speech recognition, text-to-speech systems, and translation systems, and more particularly to a load-shared distribution architecture for automatic speech recognition and text-to-speech services and translation services.

### BACKGROUND ART

Automatic Speech Recognition (ASR) and Text-to-Speech (TTS) systems are typically implemented based on a client-server architecture. An ASR server relies on the successful delivery of voice data from a network to conduct a voice recognition on the server side. However, voice delivery of the network may be vulnerable to packet drop, transmission interruption and missing information, asynchronous delivery, or large latencies. The same situation arises in the case of a TTS system. The synthesized voice from text needs to be delivered across the network, and is subject to the same defects. Often, these situations cause degraded recognition accuracy, as well as low intelligibility of the synthesized voice and delays for the client side user.

A wide variety of computing devices are generally utilized today. There is an increasing trend for the devices to be connected via networks. ASR and TTS systems are widely deployed for customer services in this network environment, for example, a packet switched network. However, the quality of these services pales when compared to the quality of service provided by conventional public switched telephone network (PSTN). Voice data is generally delivered via the Internet environment, through a network of computers called routers, in the format of a stream of packets. Voice data is delivered in a network environment in a distributed, shared and asynchronous way to achieve transmission efficiency. For example, voice over IP is one technique of this kind. The voice packets are usually received by the receiving computing devices in an asynchronous manner, and packets are sometimes lost due to heavy Internet traffic. Accordingly, the ASR and TTS systems may have lowered recognition accuracy and speech synthesis quality, resulting in an overall decreased quality of these systems.

The computational load of ASR and TTS systems is often distributed largely to the server side devices. As a consequence, the service provider may be required to invest in buying devices capable of handling the computational load. Otherwise, the service provider or the client may suffer decreased quality or reduced service items due to the limited computational resources. For example, reduction in size of possible recognition vocabulary size, or settling with limited complexity grammars.

Accordingly, a method is needed for improving the qualities of ASR and TTS systems delivered over a network.

### SUMMARY OF THE INVENTION

Accordingly, it is an object of the present invention to deliver speech systems over a network, such as the Internet, wireless network, telephone networks accurately and efficiently.

It is another object of the invention to increase the speed of delivery of the speech systems.

It is yet another object of the invention to provide improved quality of speech systems.

A further advantage of the present invention is to improve the recognition accuracy of ASR and to maintain intelligibility of TTS systems.

It is a further object of the present invention to provide delivery of speech systems over a wide range of computational devices.

Still another object of the present invention is to provide dynamic deployment of speech systems over a network.

It is yet another object of the invention to provide decreased stress on server side servers, by distributing the computational load across multiple computers over the network

Briefly, a preferred embodiment of the present invention is a method for providing a shared client-server distribution architecture for a speech system over a network. The speech system may include an automatic speech recognition system (ASR), a text-to-speech system (TTS), or a translation system. The network may include at least one of a wide area network and a local area network, or wireless network. The speech systems may be carried out over the wide area network utilizing packet-switching. A speech system is disassembled into independent modules. The modules are then divided into separate parts. A portion of a computational capacity of at least one of a plurality of devices that will be utilized by the separate parts of the modules is then determined. The modules are deployed to at least one of the plurality of devices, depending on the computational capacity thereof. The modules may be deployed by at least one of an automated process and a manual process. At least one of the plurality of devices may include at least one of a server, a personal computer, a personal digital assistant, a cell phone, a telephone, web TV, a network router, a wireless device and a bluetooth enabled device. The speech systems may be carried out in a customer service environment.

In an alternate embodiment of the present invention, the speech systems may be utilized to provide translation services. In this embodiment, speech may initially be received, the speech being associated with a first language, such as English, etc. The speech associated with the first language may be transcribed into text associated with the first language. The text associated with the first language may then be translated into text associated with a second language, such as German, etc. The text associated with the second language may then be converted into speech associated with the second language.

An advantage of the present invention is that it may be utilized, for example, in traditional client/server models.

Another advantage of the present invention is that it may further be utilized in peer to peer models.

A further advantage of the present invention is that it may provide for decreased service costs.

Yet another advantage of the present invention is significant reduction in unnecessary network traffic.

Still another advantage is effective and economical use of computational resources.

A still further advantage of the invention is a dynamic distribution architecture that can change the distribution according to the device load situations, business plan, service agreement, network load, time duration, etc.

Another advantage of the present invention is optimized resource allocation and service deployment.

These and other objects and advantages of the present invention will become clear to those skilled in the art in view of the description of the best presently known modes of carrying out the invention and the applicability of the preferred and alternate embodiments as described herein and as illustrated in the several figures of the drawings.

### BRIEF DESCRIPTION OF THE DRAWINGS

FIG. 1 is a flowchart illustrating a process for providing a load-shared distribution of automatic speech recognition and text-to-speech systems in accordance with an embodiment of the present invention;

FIG. 2 is a schematic diagram depicting the relationship between computational speed and the storage capacity of a device in accordance with an embodiment of the present invention;

FIG. 3 is a schematic diagram of the dissection of an automatic speech recognition system into functionally independent modules in accordance with an embodiment of the present invention;

FIG. 4 is a schematic diagram of module distribution to client, network, and server devices in accordance with an embodiment of the present invention;

FIG. 5 is a schematic diagram of the dissection of a text-to-speech system into functionally independent modules in accordance with an embodiment of the present invention;

FIG. 6 is a schematic illustration of a process for implementing a translation system utilizing ASR and TTS in accordance with an embodiment of the present invention; and

FIG. 7 is a schematic illustration of a process for implementing a translation system utilizing ASR and TTS in accordance with an embodiment of the present invention.

### BEST MODE FOR CARRYING OUT THE INVENTION

The present invention is a method for providing a load-shared distributed architecture for speech systems over a network.

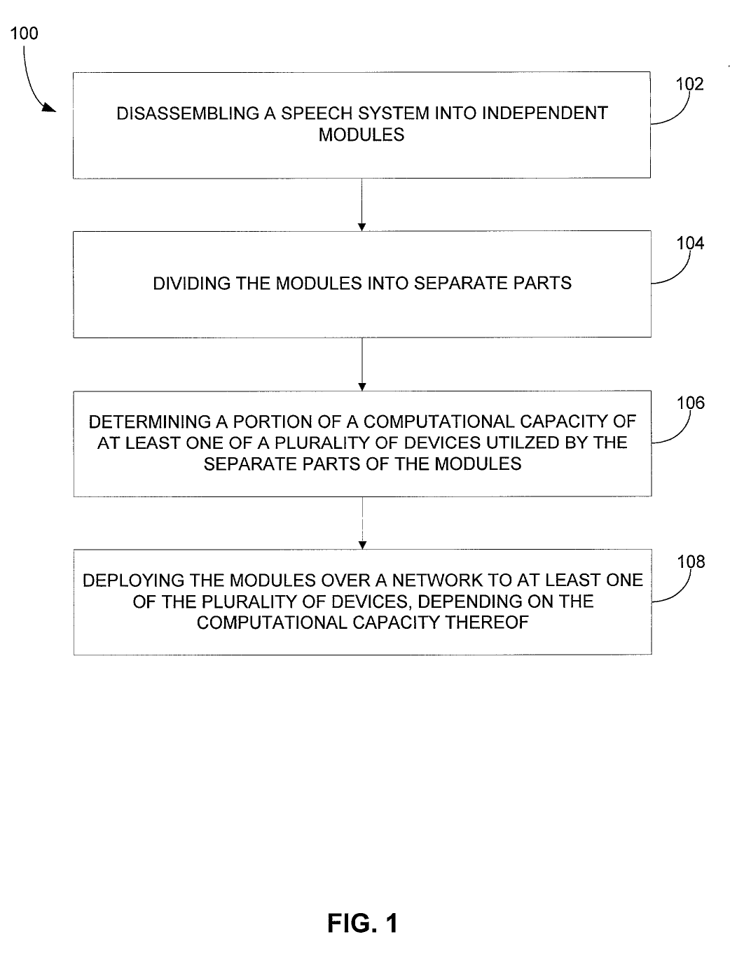

FIG. 1 is a flowchart illustrating a process 100 for providing a load-shared distribution of speech systems in accordance with an embodiment of the present invention. In operation 102, a speech system is disassembled into independent modules. The speech system may include an automatic speech recognition system (ASR), a text-to-speech system (TTS), or a translation system. The modules are divided into separate parts in operation 104. In operation 106, a portion of computational capacity of at least one of a plurality of devices utilized by the separate parts of the modules is determined. The modules are then deployed to at least one of the plurality of devices depending on the computational capacity thereof.

In one embodiment of the present invention, the speech systems may be utilized to provide translation services. In this embodiment, speech may initially be received, the speech being associated with a first language, such as English, etc. The speech associated with the first language may be transcribed into text associated with the first language. The text associated with the first language may then be translated into text associated with a second language, such as German, etc. The text associated with the second language may then be converted into speech associated with the second language.

Thus, the present invention allows for improved recognition accuracy. Further, the computational load may be evenly distributed among devices, resulting in increased efficiency. Consequently, the speech system architectures provide significant scalability.

Computational capacity may be any combination of CPU power, memory capacity, and available time. Each of these, as well as the combination thereof, may act as a limiting factor in determining how many jobs can be assigned to an entity. For example, although a computing device may have very limited amounts of CPU and memory, there are numerous such devices out there in every household. Consequently, each device can do a few jobs and collectively relieve the server of a substantial amount of burden. Further, profit may act as an impetus for server to offload jobs onto their consumers. Accordingly, the client may accept a larger share of the distribution from the server side, resulting in a decreased workload for the server side.

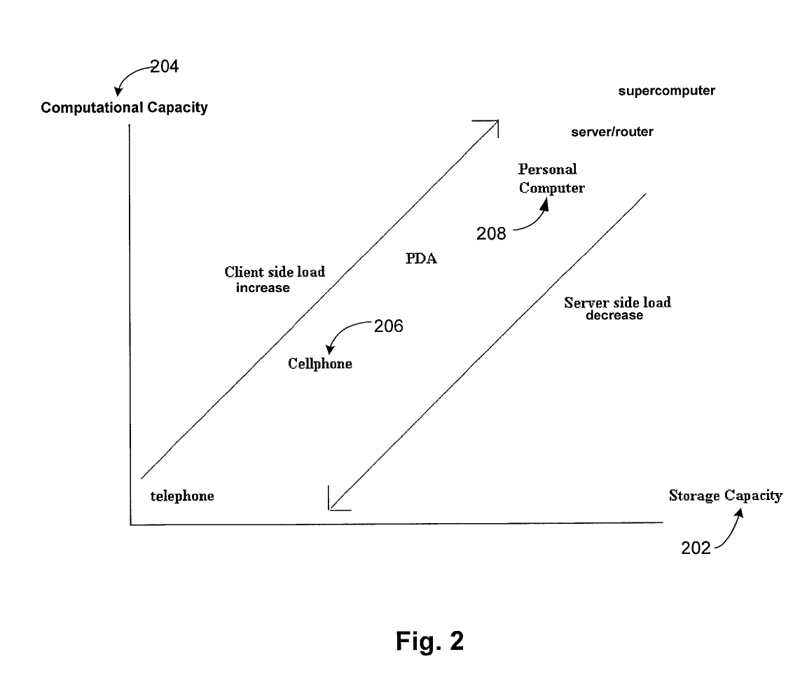

FIG. 2 is a schematic diagram depicting the relationship between computational speed and the storage capacity of a device in accordance with an embodiment of the present invention. In the current embodiment, the horizontal axis, represents the storage capacity 202 of a device. The vertical axis, represents the computation speed 204 of a device. A cell phone 206, for example, has a low computation speed and a low storage capacity. Thus, distributing part of the load to the cell phone 206 on the client side will only slightly increase the client side load, while slightly decreasing the load on the server side. As another example, a personal computer 208, has a fairly substantial computation speed and storage capacity. Therefore, distributing part of the load to the personal computer 208 on the client side will have a greater effect on the client side load and server side load. In other words, the client side load is increased to a greater degree by load distribution onto the personal computer 208 of the client than it is by load distribution onto the telephone 206 of the client. Reciprocally, the server side load is decreased by a greater degree by load distribution onto the personal computer 208 of the client than it is by load distribution onto the telephone 206 of the client. Thus, distribution of the load onto client side devices may decrease the load distributed onto server side devices, allowing for more efficient service due to the shared load distribution.

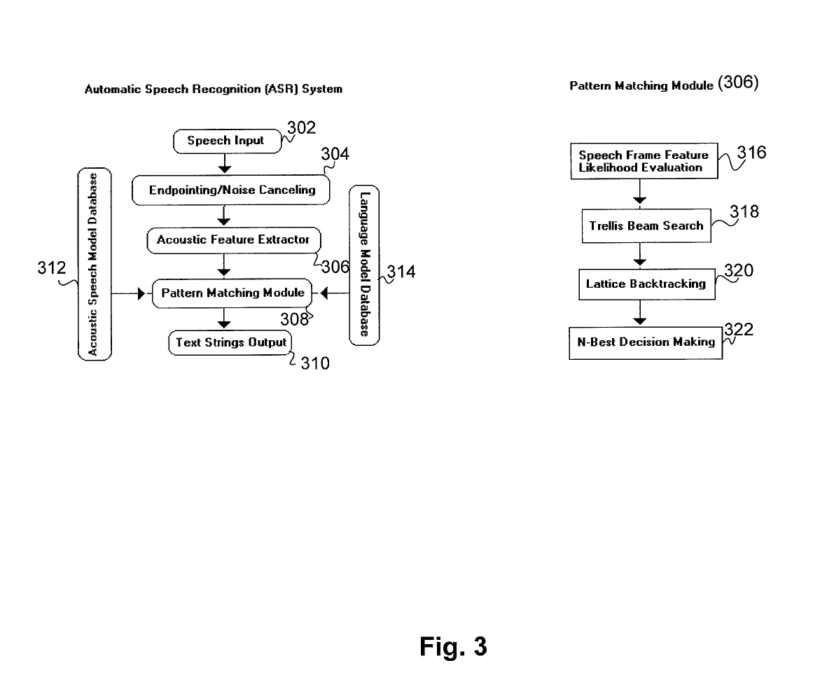

FIG. 3 is a schematic diagram of the dissection of an automatic speech recognition system into functionally independent modules in accordance with an embodiment of the present invention. Automatic Speech Recognition (ASR) systems and Text-to-Speech (TTS) systems may be dissected into modules for computational calculation and distribution purposes. In the current embodiment, an ASR system has been dissected into various modules. Speech may be input 302. Once the speech is input 302, endpointing/noise canceling may occur 304. An acoustic feature extractor 306 may be applied. A pattern matching module 308 may also perform functions with the input speech. The text strings are then output 310. The patterns for the pattern matching module 308 may be stored in a database, such as an acoustic speech model database 312 or a language model database 314. The pattern matching module 306 may include various parts. For example, as illustrated in FIG. 3, it may include a speech frame feature likelihood evaluation part 316, a trellis beam search part 318, a lattice backtracking part 320, and an N-Best decision making part 322. The computational requirements (i.e. a portion of a computational capacity utilized) of these parts may be determined. The computational requirements of the various parts may be utilized to ascertain a computational requirement of the module. The modules may then be distributed to client side devices, network devices, or server side devices depending on the computational requirements of the modules relative to the computational capacity of the respective devices.

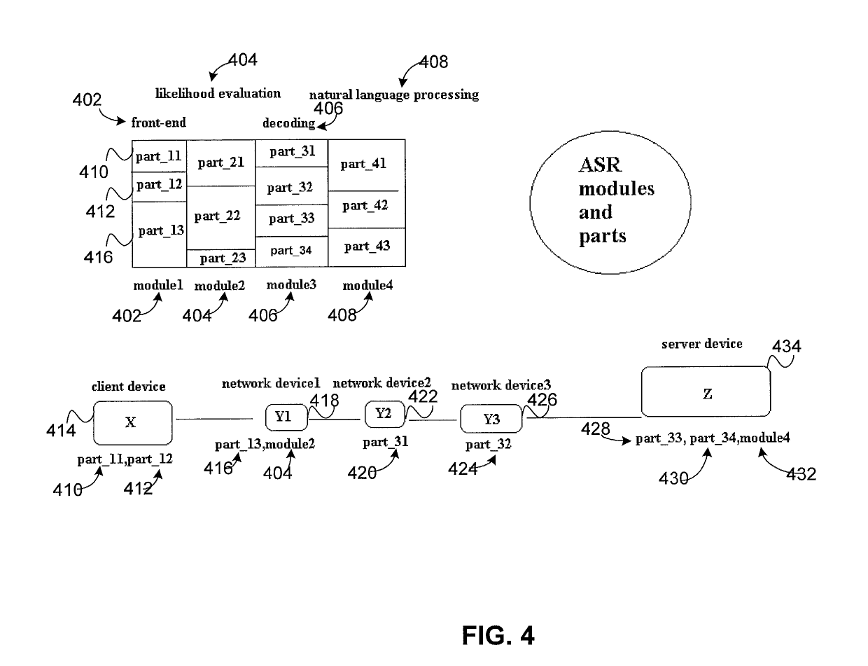

FIG. 4 is a schematic diagram of module distribution to client, network, and server devices in accordance with an embodiment of the present invention. In the current embodiment, four modules, including front-end 402, likelihood evaluation 404, decoding 406, and natural language processing 408, are dissected into their respective parts. The various parts and modules comprised thereof are distributed to various devices. For example, part_{—}11 410 and part_{—}12 412, from the front-end module 402, are deployed to X 414, a client device. Part_{—}13 416, from the front end module 402, and module 2 404 (i.e. the likelihood evaluation module) are deployed to Y1 418, a network device. Part_{—}31 420, from the decoding module 406 (i.e. module 3), is deployed to Y2 422, another network device. Part_{—}32 428, also from the decoding module 406, is deployed to Y3 426, yet another network device. Part_{—}33 428 and part_{—}34, also from the decoding module 406, and module 4 408 (i.e. the natural language processing module) are deployed to Z 434, a server device. Thus, the modules and parts thereof have been distributed to various devices that share the load in the current embodiment.

The parts of the modules may be dissected based on each individual software segment's functionality. X 414, Y1 418, Y2 422, Y3 426, and Z 434 are representative of the computational capacities of the devices they represent. The computational capacity may be a function of the computation power and the size of the random access memory (RAM) of the device. The modules and parts are distributed to the devices based on the computational capacities thereof. The distribution illustrated in FIG. 4 indicates optimal distribution, taking advantage of the computational capacity of the devices available for distribution of modules and parts thereto. The distribution exemplified in FIG. 4 may decrease unnecessary traffic over a network and release an overwhelming load from any single device. Further, the distribution may change according to dynamic computational capacities of the devices.

Preferably, the modules are functionally independent. The modularized computing jobs can be distributed among the client side, network side, and server side devices automatically or manually. In a manual embodiment, the distribution may be decided according to mutual agreement, such as a bilateral contract. Further, distribution may be decided between the server device and client device automatically.

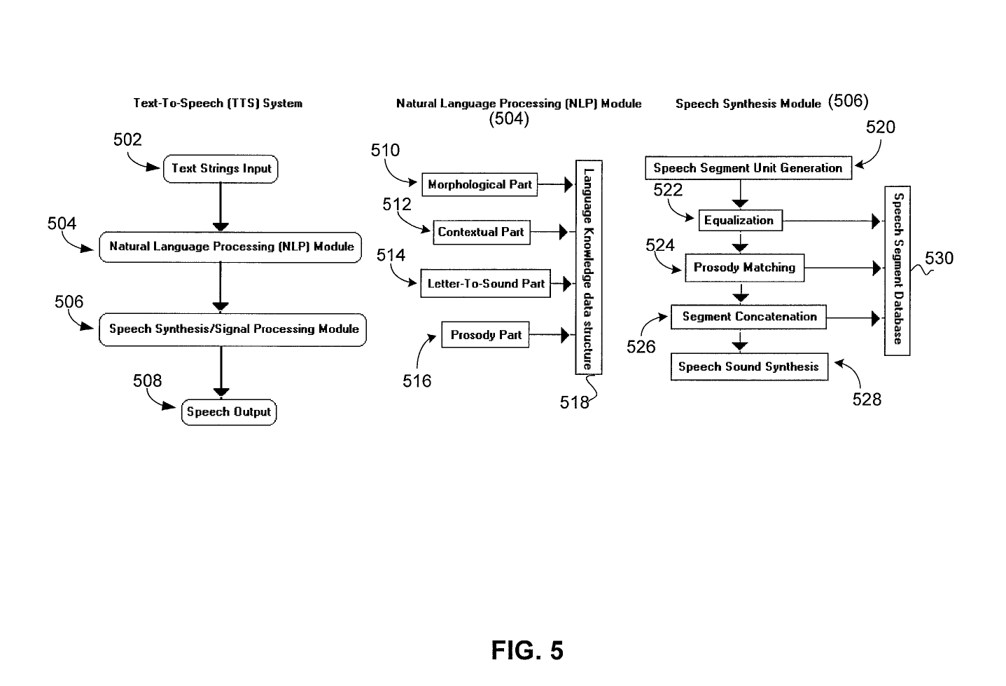

FIG. 5 is a schematic diagram of the dissection of a text-to-speech system into functionally independent modules in accordance with an embodiment of the present invention. Text strings may be input (Block 502). Once input, the text strings may be processed through a natural language processing (NLP) module (Block 504) and a speech syntheses/signal processing module (Block 506). Speech is then output (Block 508). The Natural Language Processing Module (Block 504) may include various parts. For example, it may include a morphological part (Block 510), a contextual part (Block 512), a letter-to-sound part (Block 514), and a prosody part (Block 516). Each part may be associated with a language knowledge data structure (Block 518). Similarly, the speech synthesis/signal processing module may include several parts. For instance, it may include a speech segment unit generation (Block 520) part, an equalization part (Block 522), a prosody matching part (Block 524), a segment concatenation part (Block 526), and a speech sound synthesis part (Block 528). The parts may store information in a speech segment database (Block 530).

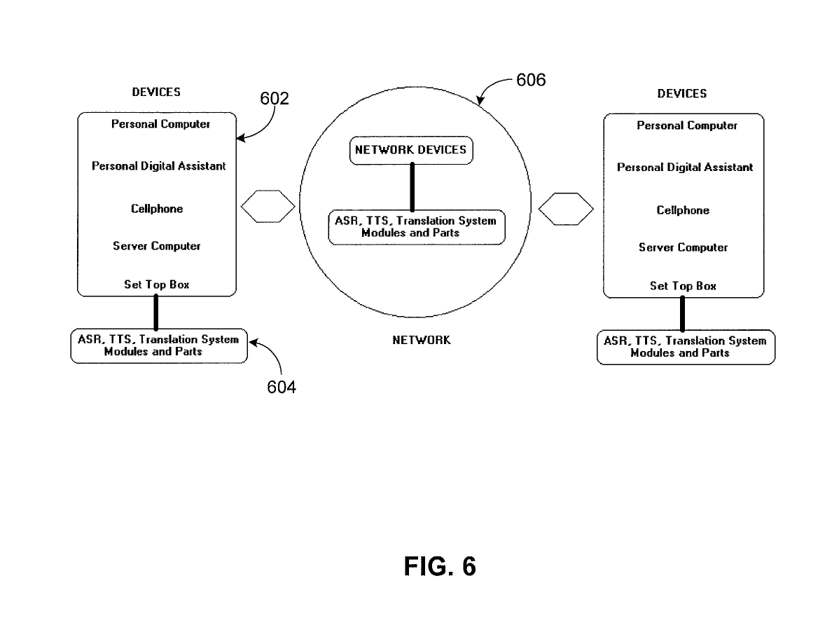

FIG. 6 is a schematic diagram of speech systems deployed over a network in accordance with an embodiment of the present invention. Various devices 602 may be utilized to distribute the modules and parts of speech systems 604, such as an ASR, TTS, or translation system, over a network 606. Network devices may also be utilized to distribute the modules and parts of the speech systems 604. The several devices have varying computational capacities. The modules may thus be distributed to the several devices dependent on the computational capacities thereof. The speech systems may be delivered over a network utilizing packet switching, to devices via a wide area network (WAN), such as the Internet, wireless network or a local area network (LAN). Further, the speech systems may be distributed utilizing a peer to peer network.

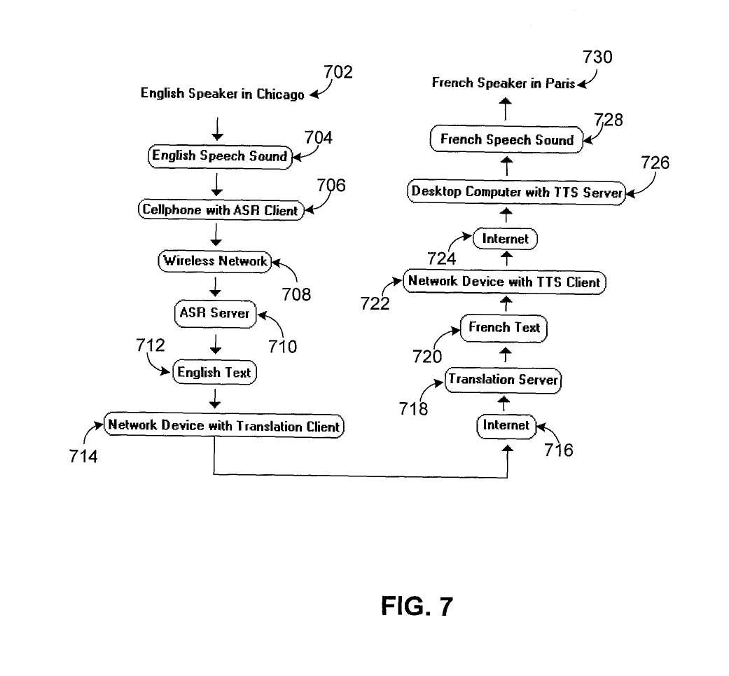

FIG. 7 is a schematic illustration of a process 700 for implementing a translation system utilizing ASR and TTS in accordance with an embodiment of the present invention. In the present example, English speech is provided in step 702, from a speaker in Chicago for instance. The English speech from step 702 forms an English speech sound (Block 704). In block 706, the English speech sound (Block 704) is communicated via a cell phone with an ASR client. The wireless network (Block 708) may transmit the speech sound from the cell phone to an ASR server (Block 710). The ASR server (Block 710) may translate the speech sound into English text (Block 712). The English text (Block 712) may then be sent via a network device with translation client (Block 714) over the Internet (Block 716). From the Internet (Block 716), the translation (i.e. English text) may be transmitted to a translation server (Block 718), which in turn translates the English text into French text (Block 720). The French text (Block 720) is then sent via a network device with TTS client (Block 722) over the Internet (Block 724) to a desktop computer with TTS server (Block 726). The desktop computer with TTS server (Block 726) translates the text into a French speech sound (Block 728), which may be communicated to a French speaker in Paris (Block 730), for example.

Algorithms in accordance with an embodiment of the present invention:

client computation capacity Xᵢ, i=1, . . . , L

computation capacity: a function of computer speed and memory size, network transmission conditions, network load conditions, network device computation capacity.

Yᵢ, i=1, . . . , M

service device computation capacity:

Zᵢ, i=1, . . . , N

ASR computation requirements:

computation requirement is a function of response time, storage size, service requirements:

Aᵢ, i=1, . . . , J

TTS computation requirements:

Tᵢ, i=1, . . . , K

Distribution Formulas in accordance with an embodiment of the present invention:

$$X = {\sum }_{i = 1}^{L} {X}_{i} Y = {\sum }_{i = I}^{M} {Y}_{i} Z = {\sum }_{i = 1}^{N} {Z}_{i} A = {\sum }_{i = 1}^{J} {A}_{i} T = {\sum }_{i = 1}^{K} {T}_{i}$$

Aₓ=client device load

A_{y}=network device load

A_{z}=server device load

Tₓ=client device load

T_{y}=network device load

T_{z}=server device load

$$\begin{matrix}{A}_{x} = A \frac{X}{X + Y + Z} \\ {A}_{y} = A \frac{Y}{X + Y + Z} \\ {A}_{z} = A \frac{Z}{X + Y + Z} \\ {T}_{x} = T \frac{X}{X + Y + Z} \\ {T}_{y} = T \frac{X}{X + Y + Z} \\ {T}_{z} = T \frac{X}{X + Y + Z}\end{matrix}$$

In addition to the above mentioned examples, various other modifications and alterations of the structure may be made without departing from the invention. Accordingly, the above disclosure is not to be considered as limiting and the appended claims are to be interpreted as encompassing the entire spirit and scope of the invention.

### INDUSTRIAL APPLICABILITY

A great need exists in the industry for load-shared distribution of ASR and TTS systems. This is especially true in systems distributed over a network. The present invention provides a load-shared distribution method which achieve the desired goals. Modularized computing jobs associated with ASR and TTS systems may be distributed among various devices associated with numerous entities. These jobs may be distributed according to the relative computational capacities of devices associates with the separate entities. Accordingly, no single entity will be burdened with an overwhelming share of the work load (job).

For the above, and other, reasons, it is expected that the load shared distribution method of the present invention will have widespread applicability. Therefore, it is expected that the commercial utility of the present invention will be extensive and long lasting.

What is claimed is:

1. A method for providing a load-shared distribution architecture for a speech system over a network comprising the steps of:
(a) disassembling a speech system into independent modules;
(b) dividing the modules into separate parts;
(c) determining a portion of a computational capacity of at least one of a plurality of devices utilized by the separate parts of the modules; and
(d) deploying the modules over a network to at least one of the plurality of devices, depending on the computational capacity thereof.

2. The method as recited in claim 1, wherein the speech system includes at least one of an automatic speech recognition system (ASR), a text-to-speech systems (TTS), and a translation system.

3. The method as recited in claim 1, wherein the network includes at least one of a wide area network, a local area network, a peer to peer network, a wireless network, and a public telephone network.

4. The method as recited in claim 3, wherein the speech system services are carried out over the wide area network utilizing packet-switching.

5. The method as recited in claim 1, wherein the speech system services are carried out in a customer service environment.

6. The method as recited in claim 1, wherein at least one of the plurality of devices includes at least one of a server, a personal computer, a personal digital assistance, a cell phone, a telephone, web TV, a network router, a wireless device, and a bluetooth enabled device.

7. The method as recited in claim 1, wherein deploying the modules includes at least one of an automated process and a manual process.

8. The method as recited in claim 1, further comprising the steps of providing a translation.

9. The method as recited in claim 8, wherein the steps of providing the translation include receiving speech associated with a first language, transcribing the speech from the first language into text, translating the speech from the first language into text associated with a second language, and converting the text associated with the second language into speech associated with the second language.

10. A computer program embodied on a computer readable medium for providing a load-shared distribution architecture for a speech system over a network comprising the steps of:
(a) a code segment that disassembles a speech system into independent modules;
(b) a code segment that divides the modules into separate parts;
(c) a code segment that determines a portion of a computational capacity of at least one of a plurality of devices utilized by the separate parts of the modules; and
(d) a code segment that deploys the modules over a network to at least one of the plurality of devices, depending on the computational capacities thereof.

11. The computer program as recited in claim 10, wherein the speech system includes at least one of an automatic speech recognition system (ASR), a text-to-speech system (TTS), and a translation system.

12. The computer program as recited in claim 10, wherein the network includes at least one of a wide area network, a local area network, a peer to peer network, a wireless network, and a public telephone network.

13. The computer program as recited in claim 12, wherein the speech system services are carried out over the wide area network utilizing packet-switching.

14. The computer program as recited in claim 10, wherein the speech system services are carried out in a customer service environment.

15. The computer program as recited in claim 10, wherein at least one of the plurality of devices includes at least one of a server, a personal computer, a personal digital assistance, a cell phone, a telephone, and web TV, a network router, a wireless device, and a bluetooth enabled device.

16. The computer program as recited in claim 10, wherein deploying the modules includes at least one of an automated process and a manual process.

17. The computer program as recited in claim 10, further comprising a code segment for providing a translation.

18. The computer program as recited in claim 17, wherein the code segment for providing a translation further includes a code segment from at least one of the group consisting of a code segment that receives speech associated with a first language, a code segment that transcribes the speech from the first language into text, a code segment that translates the speech from the first language into text associated with a second language, and a code segment that converts the text associated with the second language into speech associated with the second language.

19. A system for providing a load-shared distribution architecture for a speech system over a network comprising the steps of:
(a) logic that disassembles a speech system into independent modules;
(b) logic that divides the modules into separate parts;
(c) logic that determines a portion of a computational capacity of a at least one of a plurality of devices utilized by the separate parts of the modules; and
(d) logic that deploys the modules over a network to at least one of the plurality of devices, depending on the computational capacity thereof.

20. The system as recited in claim 19, wherein the speech system includes at least one of an automatic speech recognition systems (ASR), a text-to-speech systems (TTS), and a translation system.

21. The system as recited in claim 19, wherein the network includes at least one of a wide area network, a local area network, a peer to peer network, a wireless network, and a public telephone network.

22. The system as recited in claim 21, wherein the speech system services are carried out over the wide area network utilizing packet-switching.

23. The system as recited in claim 19, wherein the speech system services are carried out in a customer service environment.

24. The system as recited in claim 19, wherein at least one of the plurality of devices includes at least one of a server, a personal computer, a personal digital assistance, a cell phone, a telephone, web TV, a network router, a wireless device, and a bluetooth enabled device.

25. The system as recited in claim 19, wherein deploying the modules includes at least one of an automated process and a manual process.

26. The system as recited in claim 19, further comprising logic that provides a translation.

27. The system as recited in claim 26, wherein the logic for providing a translation further includes logic from at least one of the group consisting of logic that receives speech associated with a first language, logic that transcribes the speech from the first language into text, logic that translates the speech from the first language into text associated with a second language, and logic that converts the text associated with the second language into speech associated with the second language.
